(19) United States
(12) Patent Application Publication
(10) Pub. No.: US 2014/0036990 A1
(43) Pub. Date: Feb. 6, 2014

(54) SYSTEM AND METHOD FOR OPTIMIZING A VIDEO STREAM

(71) Applicant: Unwired Planet, LLC, Reno, NV (US)

(72) Inventors: Declan Harrison, Belfast (GB); Christopher Brown, Belfast (GB)

(73) Assignee: Unwired Planet, LLC, Reno, NV (US)

(21) Appl. No.: 13/957,300

(22) Filed: Aug. 1, 2013

Related U.S. Application Data
(63) Continuation of application No. PCT/EP2012/052333, filed on Feb. 10, 2012.
(60) Provisional application No. 61/442,226, filed on Feb. 12, 2011.
(60) Provisional application No. 61/478,420, filed on Apr. 22, 2011.

(51) Int. Cl. H04N 7/26

(52) U.S. Cl. CPC H04N 19/00903
USPC 375/240.01

(57) ABSTRACT

A method for optimizing a video stream, including: retrieving an original parameter set for an original bit stream in a video container received from an origin server; and writing stream-specific metadata to a header for the video container, wherein the stream-specific metadata includes the original parameter set for the original bit stream and an optimized parameter set for an optimized bit stream.

### CROSS-REFERENCE TO RELATED APPLICATIONS

This application is a continuation under 35 U.S.C. §120 of International Application No. PCT/EP2012/052333, filed on Feb. 10, 2012 and published in the English language by the International Bureau as WO 2012-107570 A1 on Aug. 16, 2012, which claims priority to each of (1) U.S. Provisional Patent Application No. 61/442,226, filed on Feb. 12, 2011; and (2) U.S. Provisional Patent Application No. 61/478,420, filed on Apr. 22, 2011. Each of the above-referenced applications is hereby incorporated by reference in its entirety.

### BACKGROUND OF THE INVENTION

1. Field of the Invention

The present application relates to a method for optimizing a video stream and a media optimization system.

2. Description of the Related Technology

When video content is streamed to a client device over a remote connection—whether over a network connection, an Internet connection or otherwise—the video stream may require optimization to allow for continuous playback over the connection due to bandwidth, hardware, or other limitations. Continuous playback, such as in hypertext transfer protocol (HTTP) progressive download, allows the client to begin viewing the video stream before the complete video is downloaded, which may be especially useful for large video files or live video streams.

An optimized video stream is generally encoded using rate controls, profiles, and/or levels that differ from the original video stream. Encoding the video stream includes reducing the quantity of data used to represent the digital images displayed in the raw video and may include compressing the spatial images and temporal motion compensation. Encoding the video reduces the transmission bandwidth to allow the video to be played back continuously.

### SUMMARY

Embodiments of a system are described. In one embodiment, the system is a media optimization system. The system includes: a receiver configured to retrieve an original parameter set for an original bit stream in a video container received from an origin server, wherein the original parameter set is stored on a memory device; and a configuration engine configured to write stream-specific metadata to a header for the video container, wherein the stream-specific metadata includes the original parameter set for the original bit stream and an optimized parameter set for an optimized bit stream. Other embodiments of the system are also described.

Embodiments of a computer program product are also described. In one embodiment, the computer program product includes a computer readable storage device to store a computer readable program, wherein the computer readable program, when executed by a processor within a computer, causes the computer to perform operations for optimizing a video stream. The operations include: retrieving an original parameter set for an original bit stream in a video container received from an origin server; and writing stream-specific metadata to a header for the video container, wherein the stream-specific metadata includes the original parameter set for the original bit stream and an optimized parameter set for an optimized bit stream. Other embodiments of the computer program product are also described.

Embodiments of a method are also described. In one embodiment, the method is a method for optimizing a video stream. The method includes: retrieving an original parameter set for an original bit stream in a video container received from an origin server; and writing stream-specific metadata to a header for the video container, wherein the stream-specific metadata includes the original parameter set for the original bit stream and an optimized parameter set for an optimized bit stream. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a media optimization system.

FIG. 2 depicts a schematic diagram of one embodiment of the proxy of FIG. 1.

FIG. 3 depicts a flow chart diagram of one embodiment of a method for data flow through the media optimization system of FIG. 1.

FIG. 4 depicts a flow chart diagram of one embodiment of a method for data flow through the media optimization system of FIG. 1.

FIG. 5 depicts a flow chart diagram of one embodiment of a method for inserting data into a video stream.

Throughout the description, similar reference numbers may be used to identify similar elements.

### DETAILED DESCRIPTION OF CERTAIN INVENTIVE EMBODIMENTS

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention. Reference throughout this specification to “one embodiment,” “ an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a system and method for optimizing a video stream. More specifically, the system optimizes a video stream encoded using an H.264 codec such that the video stream may be played continuously at a client device. The system includes inserting sequence parameter set (SPS) and picture parameter set (PPS) entries into an advanced video coding (AVC) decoder configuration record (DCR). As is known an SPS contains parameters to be applied to a complete video sequence. Amongst others, typical SPS parameters include limits on frame numbers, picture order count, and decoded picture width and height. A PPS contains parameters which are applied to one or more decoded pictures within a sequence. Amongst others, typical PPS parameters include the number of slice groups in use and initial quantizer parameters. The system described herein provides a way to allow continuous playback of H.264 video content.

The DCR is an H.264 specific network abstract layer (NAL) packet that is used by player and decoders at the client to read the individual H.264 bit streams in the video container used by a video player. The system may assume that the encoder used to re-encode the H.264 content can specify a separate SPS Identifier and PPS Identifier for each bit stream, such that the client is able to identify which SPS and PPS entries correspond to a given bit stream. While the system described herein presents embodiments for H.264 content, other embodiments may include other types of video content, and the operations and terminology of the system described herein may be modified according to the particular formatting of the video content.

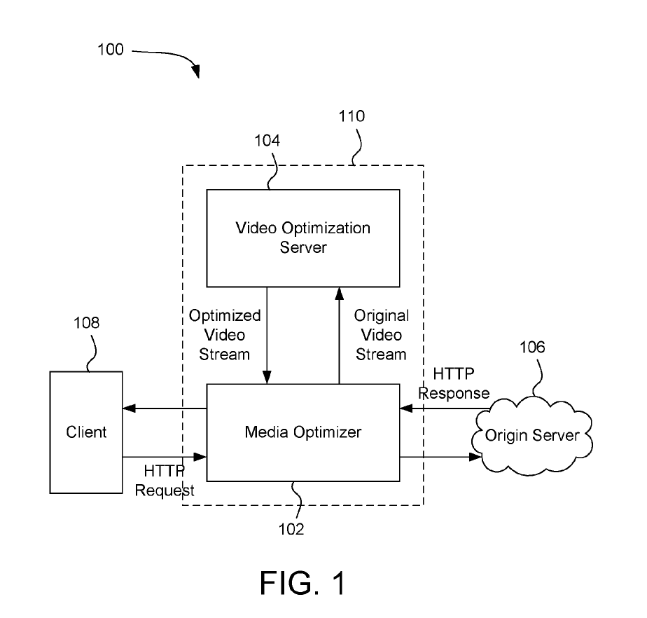

FIG. 1 depicts a schematic diagram of one embodiment of a media optimization system 100. In one embodiment, the media optimization system 100 includes a media optimizer 102 and a video optimization server (VOS) 104 between an origin server 106 and a client 108. Although the media optimization system 100 is shown and described with certain components and functionality, other embodiments of the media optimization system 100 may include fewer or more components to implement less or more functionality.

In one embodiment, the media optimization system 100 dynamically optimizes H.264 (or other) video content over a network layer—such as via hypertext transfer protocol (HTTP)—using multiple bit streams. Other embodiments may use other protocols compatible with H.264 content. In one embodiment, the media optimization system 100 includes a proxy 110. The proxy is located between the client and the origin server 106. The proxy is configured to intercept the video container in the video stream from the origin server 106. In one embodiment, the proxy includes the media optimizer 102 and the VOS 104. In another embodiment, the proxy includes more or fewer components than described herein. The proxy intercepts an original video bit stream in an HTTP response for the video stream and performs operations on the bit streams. The media optimizer 102 may send the original bit stream to the VOS 104 to perform additional operations, including optimization of the bit stream. The VOS 104 may return an optimized bit stream to the media optimizer 102, which then forwards the optimized signal to the client. The optimization of the video is conducted in real-time, such that the video stream is played back continuously at the client.

Each bit stream represents the same sequence of images, but each bit stream may be encoded using different rate controls and potentially different profiles (H.264 profiles) and levels (H.264). Re-encoded H.264 content may be viewed progressively (HTTP Progressive Download) by the client, i.e., client is able to start viewing video before the complete video is downloaded. This may be particularly useful for large video sizes, high quality videos, or live video streams.

In one embodiment, optimizing the bit streams includes re-encoding and compressing the bit streams to reduce video size and bandwidth used by the video stream. A multiplexer (not shown)—in formats such as Flash Video, MP4, or any video container that supports H.264 encoding—at the media optimizer 102 packages the re-encoded compressed H264 video and audio content and interleaves this data in such a way that the client player can understand and playback the images correctly in the correct time sequence. Various embodiments of the system 100 may be implemented. In one embodiment, a client requests a video clip from an origin server 106. In one embodiment, a proxy initially sends the video and audio content unaltered (in its original form) to the client. After a period of time has elapsed, the VOS 104 is signaled to start compressing or optimizing the content. The signal may be sent as a result of the media optimization system 100 making a determination that the connection between the client and the origin server 106/media optimizer 102 does not have sufficient bandwidth at the present time to support the unaltered video stream. The VOS 104 receives the signal and starts compressing this content at the next key video frame. The H.264 stream from this point is effectively a different bit stream of the same sequence of images from the original stream.

In one embodiment, the system 100 described herein covers the specific details required at the multiplexer level to allow the H264 video content to be played back progressively at the client. This may include the VOS 104 dynamically inserting SPS and PPS entries into the AVC DCR. The SPS and PPS entries provide information for a particular bit stream. In some embodiments, the SPS and PPS entries may be in table format, and the VOS 104 reads each entry in the tables to determine bit rate, image resolution, and/or other playback information related to the particular bit stream.

In one embodiment, when content is passed to the VOS 104, the VOS 104 first determines if it needs to dynamically inject multiple SPS and PPS entries into the AVC DCR. In one embodiment, the VOS 104 injects multiple SPS and PPS entries into the AVC DCR if (1) the input container video codec used is H264; (2) the output container video codec used is H264; (3) VOS 104 configuration indicates that it needs to send multiple bit streams.

The AVC DCR or other configuration record may include a parameter that indicates the type of codec that was used. In one embodiment, the VOS 104 determines that multiple bit streams need to be sent to the client based on the bandwidth of the connection and the size of the video stream. Each bit stream may be optimized to use a certain amount of bandwidth, such that the bit streams cover a range of bandwidths. In another embodiment, the VOS 104 may make the determination based on other factors, such as hardware limitations of the client, media optimization system 100, and/or the origin server 106. In another embodiment, the media optimizer 102 monitors some or all of the parameters relating to the connection to determine whether multiple bit streams are required, and indicates to the VOS 104 which bit streams will be used. The VOS 104 may only create one optimized bit stream selected from the possible bit streams to be used.

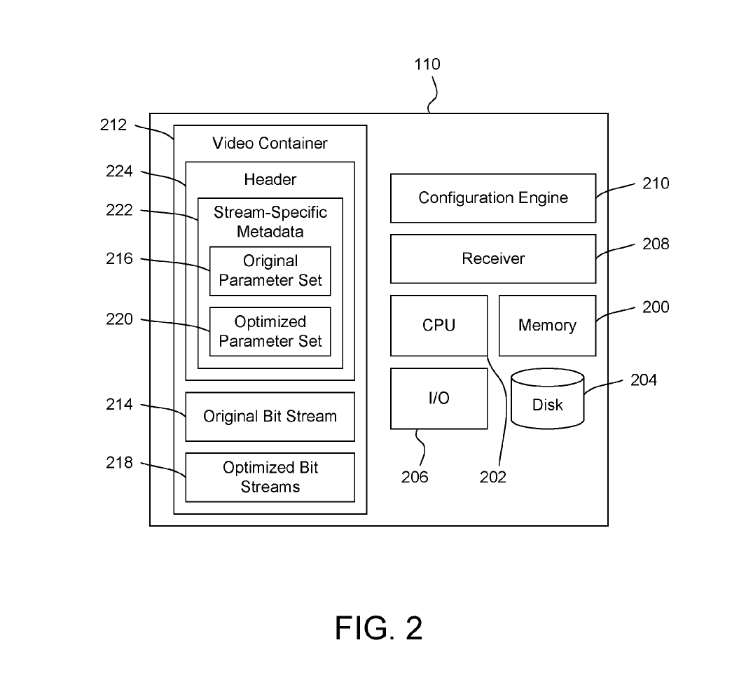

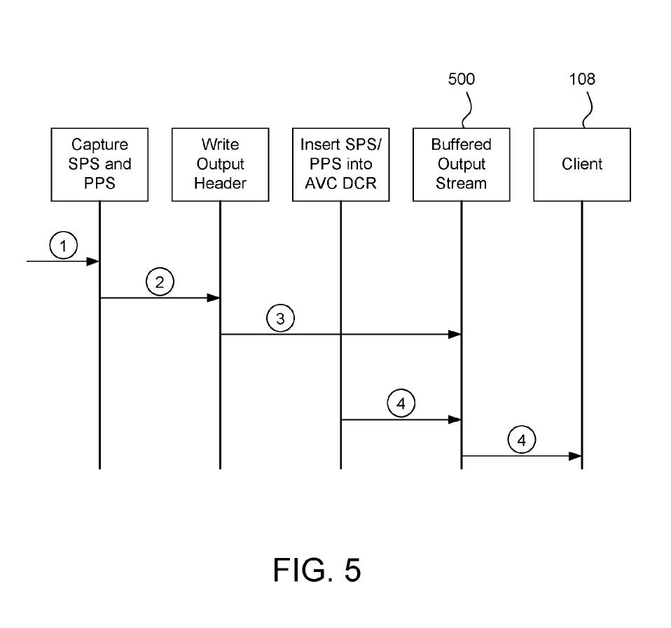

FIG. 2 depicts a schematic diagram of one embodiment of the proxy 110 of FIG. 1. The depicted proxy 110 includes various components, described in more detail below, that are capable of performing the functions and operations described herein. In one embodiment, at least some of the components of the proxy 110 are implemented in a computer system. For example, the functionality of one or more components of the proxy 110 may be implemented by computer program instructions stored on a computer memory device 200 and executed by a processing device 202 such as a CPU. The proxy 110 may include other components, such as a disk storage drive 204, input/output devices 206, a receiver 208, and a configuration engine 210. Some or all of the components of the proxy 110 may be stored on a single computing device or on a network of computing devices. The proxy 110 may include more or fewer components than those depicted herein. In some embodiments, the proxy 110 may be used to implement the methods described herein as depicted in FIG. 5.

In one embodiment, the proxy 110 includes a receiver 208. The receiver 208 is configured to receive a video container 212 corresponding to an original bit stream 214. In one embodiment, the receiver 208 is at the VOS 104 and is configured to receive the video container 212 from the media optimizer 102. The video container 212 is received by the media optimizer 102 in an HTTP response from the origin server 106 corresponding to an HTTP request from the client 108. The receiver 208 retrieves an original parameter set 216 corresponding to the original bit stream 214 in the video container 212. The original parameter set 216 may be stored in the memory device while the proxy 110 is performing the operations described herein. In one embodiment, the original parameter set 216 includes original SPS and PPS entries for the original bit stream 214. The proxy 110 also includes a configuration engine 210. In one embodiment, the configuration engine 210 is configured to write stream-specific metadata 222 to a header 224 for the video container 212. In one embodiment, the header 224 is an AVC DCR for an H.264 video container 212. The configuration engine 210 determines a number of possible optimized bit streams 218 that may be used for the video stream to the client 108. The number of possible optimized bit streams 218 may be as many as needed to allow a continuous stream to the client 108, while also providing the best image quality.

The stream-specific metadata 222 includes the original parameter set 216 corresponding to the original bit stream 214. The metadata 222 also includes optimized parameter sets 220 for each of the possible optimized bit streams 218. In one embodiment, the original parameter set 216 includes original SPS and PPS entries, and the optimized parameter sets 220 include optimized SPS and PPS entries for each of the possible optimized bit streams 218 that may be used. The configuration engine 210 may determine the number of possible optimized bit streams 218 by analyzing the original parameter set 216 that is retrieved from the original bit stream 214. The proxy 110 may create the optimized bit stream 218 as needed during playback after inserting the optimized parameter sets 220 into the header 224, and then forward the optimized bit stream 218 to the client 108.

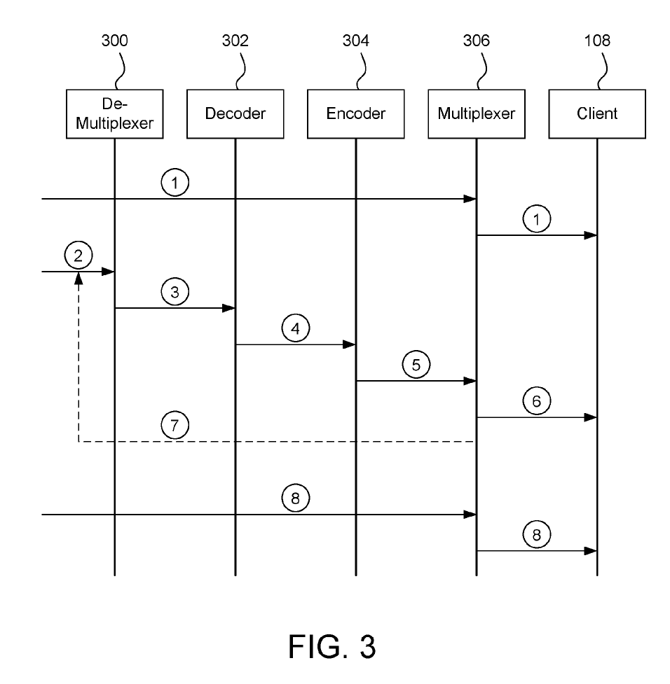

FIG. 3 depicts a flow chart diagram of one embodiment of a method for data flow through the media optimization system 100 of FIG. 1. Specifically, the method of FIG. 3 shows a bit stream through the VOS 104 when no additional SPS or PPS entries are injected into the data stream. The method may be used in conjunction with the media optimization system 100 of FIG. 1. In other embodiments, the method may be used in conjunction with other media optimization systems 100.

The method may be implemented at least partially or wholly in the VOS 104 of FIG. 1, shown below. In one embodiment, the VOS 104 includes a de-multiplexer, a decoder, an encoder, and a multiplexer, each to perform at least some of the operations of the method.

1. The VOS 104 writes container header data. This is format dependant. The VOS 104 typically writes any specific headers 224 the container format requires. The VOS 104 then iterates through all defined streams for this container 212 and writes the required stream-specific metadata 222. For H.264 streams this means writing the AVC DCR, which includes one SPS and PPS entry.

2. The VOS 104 reads video content corresponding to the video container 212 from the origin server 106.

3. The de-multiplexer 300 extracts a video or audio packet from the video content and extracts a frame of compressed video content.

4. The decoder 302 receives the compressed input frame and outputs a completely uncompressed buffer, which may include the raw video content.

5. The video encoder 304 takes the uncompressed video content and compresses the content. The output is compressed more than the original frame in an optimized manner.

6. The multiplexer 306 takes the frame of compressed video content and multiplexes it with audio content and sends multiplexed content to the client 108 in the correct container format, e.g., flash video packet or mp4 packet.

7. Operations 2-6 are repeated until the end of the input data.

8. The VOS 104 then writes container trailer data that is dependent on the format.

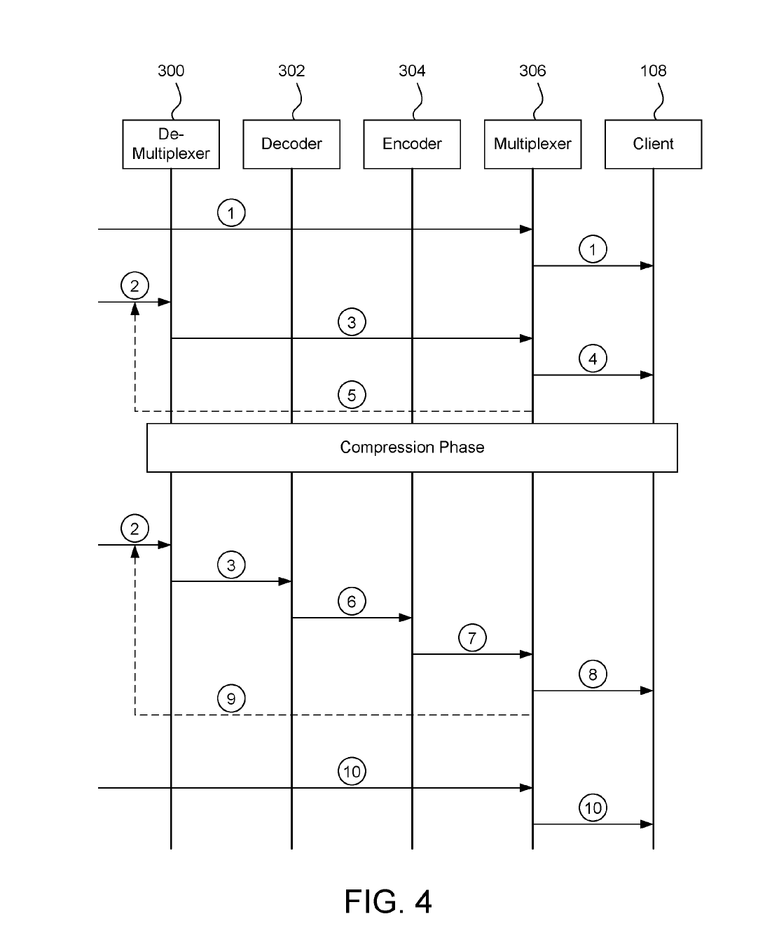

FIG. 4 depicts a flow chart diagram of one embodiment of a method for data flow through the media optimization system 100 of FIG. 1. In embodiments where the media optimization system 100 determines that it needs to perform dynamic SPS/PPS injection, the media optimization system 100 may then decide how many SPS and PPS entries to inject into the AVC DCR. In one embodiment, the media optimization system 100 is a VOS 104. The number of SPS and PPS entries to be injected is dependent on the number of bit streams that require encoding or optimizing, minimally at least two. FIG. 4 shows one embodiment where the VOS 104 determines that it needs to inject an additional SPS and PPS entry from the original stream into the output-generated AVC DCR.

In this embodiment, there are two distinct phases: a first phase in which the original input video packets are sent, and a second phase (compression phase) in which the dynamically optimized video packets are sent. In one embodiment, the dynamically optimized video packets contain two distinct bit streams representing the same sequence of images.

1. The VOS 104 writes container-specific header data. This is format dependent.

The VOS 104 typically writes any specific headers 224 the container format requires. The VOS 104 then iterates through all defined streams for this container 212 and writes the required stream-specific metadata 222. For H.264 streams this means writing the AVC DCR, which includes one SPS and PPS entry. Additionally the VOS 104 dynamically inserts the original SPS and PPS into this generated AVC DCR.

2. The VOS 104 reads video content from the origin server 106.

3. The de-multiplexer 300 extracts a video or audio packet and extracts a frame of compressed video content.

4. The multiplexer 306 takes the frame of compressed video content, multiplexes it with audio content, and sends the multiplexed content to the client 108 in the correct container format. In the present embodiment, the format is for flash video.

5. Operations 2-4 are repeated until the VOS 104 is signaled to start the compression phase, i.e., start re-encoding the video content.

6. When the VOS 104 is signaled to the start the compression phase, the VOS 104 enters the compression phase on the next key frame. The decoder 302 receives the compressed input frame and outputs a completely uncompressed buffer, which may include the raw video content.

7. The video encoder 304 takes the uncompressed video content and compresses the content. The output is compressed more than the original frame.

8. The multiplexer 306 takes the frame of compressed video content and multiplexes it with audio content and sends the multiplexed content to the client 108 in the correct container format, e.g., flash video.

9. Operations 2, 6, 7 and 8 are repeated until the end of the input data.

10. The VOS 104 then writes container trailer data that is dependent on the format. In this embodiment, if the VOS 104 does not dynamically insert the original SPS and PPS entries of the original input video container 212 into the AVC DCR of the new header 224 generated by the VOS 104, then the initial part of the video—the un-compressed phase—will not play at the client 108. In order for the content to be played, the original SPS and PPS entries are inserted into the correct location.

FIG. 5 depicts a flow chart diagram of one embodiment of a method for inserting data into a video stream. Although the method 500 is described in conjunction with the media optimization system 100 of FIG. 1, embodiments of the method 500 may be implemented with other types of media optimization systems 100. The method of FIG. 4 provides more details on when and how the media optimization system 100 dynamically inserts the original SPS and PPS entries into the output-optimized generated streams.

In one embodiment, the VOS 104 performs some or all of the operations of the method 500, as described below:

1. The VOS 104 captures the original SPS and PPS from the original stream's AVC DCR. This is done before de-multiplexing the input stream. The original SPS and PPS entries are analyzed to find the next available identifier to use when creating the output H264 stream coders.

2. The VOS 104 writes container header data. This is format dependent. The VOS 104 typically writes any specific headers 224 required by the container format. The VOS 104 then iterates through the defined streams for this container 212 and writes the required stream-specific metadata 222. For H.264 streams, this means writing the AVC DCR, which includes one SPS and PPS entry. The VOS 104 may ensure that the SPS identifier and the PPS identifier chosen are monotonically correct when joined with the original SPS and PPS identifiers.

3. The header data including the AVC DCR is sent to buffered output stream.

4. The VOS 104 intercepts the container header data before it is sent to the client 108 (using a buffered input/output stream 500) and inserts the original SPS and PPS entries into the new stream's AVC DCR SPS and PPS table. Each original SPS and PPS entry is inserted in the correct location in the relevant SPS and PPS table. The SPS and PPS tables are keyed on the SPS Identifier and the PPS Identifier, and thus the SPS and PPS entries are inserted into the correct location. The VOS 104 may also allow for an input stream having more than one SPS and PPS entry.

The media optimization system 100 may rely on being included in an HTTP proxy server. In some embodiments of the media optimization system 100, the system 100 may also include another network element to signal the VOS 104 to start compressing video. Such an operation or additional operations may be performed by one or more separate software products, such as a media optimization product on a media optimizer 102. This may include:

1. On process startup, the VOS 104 listens for an HTTP Post request from the media optimizer 102.

2. Each HTTP response that sends back video content to the client 108 that has not been cached may be redirected by the media optimizer 102 to the VOS 104. The VOS 104 may then send back the original or re-encoded video content to the media optimizer 102, which then forwards this content on to the client 108. The media optimization system 100 may run as long as the HTTP proxy server is active.

In one embodiment, the VOS 104 inserts the original parameter set 216 for the original bit stream 214, such that the video in the pre-compressed phase will play on the client 108, and the optimized parameter sets 220 for each of the optimized bit streams 218 such that the video for each subsequent compressed phase will play on the client 108. In some embodiments, the method includes capturing the original parameter set 216 from a configuration record of the original bit stream 214, determining a number of possible bit streams to be used, and inserting the optimized parameter set 220 for each of the possible optimized bit streams 218 into the header 224. In some embodiments, the number of possible optimized bit streams 218 may be determined using the original parameter set 216 to identify a range of possible/likely optimization parameters. After the header 224 has been written with the stream-specific metadata 222, the media optimization system 100 may optimize the original bit stream 214 and send the optimized bit stream 218 to a client 108. The optimized bit stream 218 sent to the client 108 may be determined by a present state of the connection to the client 108 or by other/additional factors.

An embodiment of a media optimization system 100 includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to optimize a video stream.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD). Hardware implementations including computer readable storage media also may or may not include transitory media. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for optimizing a video stream, the method comprising:
retrieving an original parameter set for an original bit stream in a video container received from an origin server; and
writing stream-specific metadata to a header associated with the video container, wherein the stream-specific metadata includes the original parameter set for the original bit stream, and
wherein the stream-specific metadata further includes an optimized parameter set for an optimized bit stream.

2. The method of claim 1, wherein the original parameter set comprises an original sequence parameter set and an original picture parameter set, and wherein the optimized parameter set comprises an optimized sequence parameter set and an optimized picture parameter set.

3. The method of claim 1, further comprising intercepting the video container in a video stream from the origin server at a proxy prior to retrieving the original parameter set for the original bit stream.

4. The method of claim 1, further comprising:
capturing the original parameter set from a configuration record of the original bit stream;
determining a number of possible optimized bit streams to be used; and
inserting the optimized parameter set for each of the possible optimized bit streams into the header.

5. The method of claim 4, wherein determining the number of possible optimized bit streams to be used comprises analyzing the original parameter set.

6. The method of claim 4, wherein the determined number of possible optimized bit streams to be used is based on a bandwidth of a connection to a client device, a size of the video stream, at least one or more of hardware limitations of a client device and software limitations of a client device, at least one or more of hardware limitations of a media optimization system and software limitations of a media optimization system, and at least one or more of hardware limitations of the origin server and software limitations of the origin server.

7. The method of claim 1, further comprising:
optimizing the original bit stream after writing the stream specific metadata to the header; and
sending the optimized bit stream to a client.

8. The method of claim 1, further comprising encoding the original bit stream and the optimized bit stream using an H.264 codec.

9. A media optimization system, comprising:
a receiver configured to retrieve an original parameter set for an original bit stream in a video container received from an origin server, wherein the original parameter set is stored on a memory device; and
a configuration engine configured to write stream-specific metadata to a header associated with the video container, wherein the stream-specific metadata includes the original parameter set for the original bit stream, and wherein the stream-specific metadata further includes an optimized parameter set for an optimized bit stream.

10. The media optimization system of claim 9, wherein the video container is encoded using an H.264 codec, and wherein the original parameter set comprises an original sequence parameter set and an original picture parameter set, and wherein the optimized parameter set comprises an optimized sequence parameter set and an optimized picture parameter set.

11. The media optimization system of claim 10, wherein the configuration engine is further configured to:
determine a number of possible optimized bit streams to be used; and
insert the optimized parameter set for each of the possible optimized bit streams into the header.

12. The media optimization system of claim 11, wherein the configuration engine is further configured to determine a number of possible optimized bit streams to be used by analyzing the original parameter set.

13. The media optimization system of claim 11, wherein the configuration engine is further configured to determine the number of possible optimized bit streams to be used based on a bandwidth of a connection to a client device, a size of the video stream, at least one of hardware or software limitations of a client device, at least one of hardware or software limitations of the system, and at least of one hardware or software limitations of the origin server.

14. The media optimization system of claim 9, further comprising a proxy configured to intercept the video container in a video stream from the origin server.

15. The media optimization system of claim 14, wherein the proxy is further configured to:
optimize the original bit stream to the optimized bit stream after writing the stream specific metadata to the header; and
send the optimized bit stream to a client.
